(19) United States
(12) Patent Application Publication
(10) Pub. No.: US 2026/0172222 A1
(43) Pub. Date: Jun. 18, 2026

(54) METHOD AND SYSTEM FOR PROCESSING ENCRYPTED DATA COMPRISING AN EVALUATION OF A CLIENT'S ENCRYPTED DATA VECTOR BY AT LEAST ONE DECISION TREE PROVIDED BY A SERVER

(71) Applicant: Commissariat à l’Energie Atomique et aux Energies Alternatives, Paris (FR)

(72) Inventors: Aymen BOUDGUIGA, Cedex (FR); Jean-Paul BULTEL, Cedex (FR); Marina CHECRI, Cedex (FR); Pierre-Emmanuel CLET, Cedex (FR); Olive CHAKRABORTY, Cedex (FR); Renaud SIRDEY, Cedex (FR)

(73) Assignee: Commissariat à l’Energie Atomique et aux Energies Alternatives, Paris (FR)

(21) Appl. No.: 19/423,577

(22) Filed: Dec. 17, 2025

(30) Foreign Application Priority Data
Dec. 17, 2024 (FR) FR2414354

(51) Int. Cl. H04L 9/00; H04L 9/08

(52) U.S. Cl. CPC H04L 9/008; H04L 9/0825

(57) ABSTRACT

This method comprises, for the evaluation of a client's encrypted data vector by at least one decision tree (22) provided by a server (6), in a comparison phase: by a first execution environment, implementing a homomorphic encryption scheme, calculation (52, 54) of an evaluation vector, comprising encrypted components representing a difference between a component of the encrypted data vector and a decision threshold value associated with a corresponding node of said at least one decision tree, and provision of the evaluation vector to a second execution environment which is a secure execution environment, executed by said server but controlled by said client, and, by the second secure execution environment:
decryption (56) of said evaluation vector by applying a private key of said client, determination (58) of the sign of each component of the decrypted evaluation vector and provision of an encrypted sign vector to the first execution environment.

This application claims priority to French Patent Application No. 24 14354 filed Dec. 17, 2024, the entire disclosure of which is incorporated by reference herein.

### FIELD OF THE INVENTION

This invention relates to a method and system for processing encrypted data comprising an evaluation of a client's encrypted data vector by at least one decision tree provided by a server.

The invention is in the field of digital data encryption and the processing of encrypted digital data.

The encryption of digital data is critical for many applications, to protect confidential digital data, whether it is medical, industrial or banking data.

### BACKGROUND OF THE INVENTION

Many applications require the implementation of calculations on digital data, and it is common to propose performing heavy calculations on computing servers made available to various clients. In particular, calculations implementing artificial intelligence methods, developed by machine learning, are offered by servers. In such a context, it is critical to ensure the protection and confidentiality of both the client's digital data and the specific parameters of the artificial intelligence methods implemented by the servers.

Indeed, the development of artificial intelligence methods by machine learning requires making algorithmic choices, to define an artificial intelligence model to apply, and learning the model's parameters, which are very numerous. The learning phase uses many computational resources and pre-collected training data, with the collection and storage of training data also being long and costly.

Thus, in such an application framework, each participant, the client and the respective server, needs to protect their own digital data. The protection of digital data is achieved through encryption.

Particular public and private key encryption/decryption schemes are known, with these keys being distinct, with the private key being secret and personal, known only to the data owner. Only the holder of the private key can decrypt the encrypted digital data with the corresponding public key.

Moreover, confidential computing systems using homomorphic encryption have been developed. This confidential computing system allows for the implementation of addition/subtraction and multiplication operations on encrypted data to obtain an encrypted result without having to perform decryption. The result of any operation on encrypted data (an operation performed “blindly”) corresponds to the result of applying the same operation without encryption (an operation “in the clear”). This advantageously allows delegating calculations to an external server without the external server decrypting the encrypted data, thus enabling the delegation of calculations while maintaining data confidentiality. After performing the calculations in the encrypted domain using the homomorphic encryption scheme, the server transmits the encrypted result to the client, who decrypts the result using their private key.

However, calculations on encrypted data in a homomorphic encryption system are heavy, use many computational resources, and require a long time.

An object of the invention is to propose a more efficient remote processing of encrypted data while ensuring the confidentiality of the processed data.

The invention applies more particularly to the confidential evaluation of a client's encrypted data vector by at least one decision tree provided by a server. Here, confidential evaluation means an evaluation that does not give access to the client's decrypted data (or data in the clear).

An additional objective of the invention is to also preserve the confidentiality of the operations and data specific to the server performing the calculations.

### SUMMARY OF THE INVENTION

To this end, the invention relates to a method for processing encrypted data comprising an evaluation of a client's encrypted data vector by at least one decision tree provided by a server, the client's encrypted data vector being of dimension K, less than or equal to the number of nodes of said at least one decision tree, the evaluation of the encrypted data vector by at least one decision tree, comprising a phase of comparing the components of the encrypted data vector to decision threshold values associated with the nodes of said at least one decision tree, and a phase of traversing the at least one decision tree, based on the result of the comparison phase, to obtain an encrypted decision result.

This method is implemented by said server and comprises, in the comparison phase: by a first execution environment, implementing a homomorphic encryption scheme, a calculation of an evaluation vector, comprising encrypted components, each representing a difference between a component of the encrypted data vector and a decision threshold value associated with a corresponding node of said at least one decision tree,
provision of the evaluation vector to a second execution environment, which is a secure execution environment, executed by said server but controlled by said client,
by the second secure execution environment:
   decryption, by applying a private key of said client, previously recorded in the secure execution environment, of said evaluation vector,
   determination of the sign of each component of the decrypted evaluation vector and provision of at least one encrypted sign vector resulting from said sign determination to said first execution environment.

Advantageously, the proposed method uses both a first execution environment, managed by the server, and a second secure execution environment, in the phase of comparing the components of the encrypted data vector to decision threshold values associated with the nodes of the decision tree. The second secure execution environment is managed by the client and comprises client information, in particular the client's private key that allows the decryption of encrypted data. The second secure execution environment is installed on the server, but isolated, so that the information and data processed in this second secure execution environment are not accessible to the server. Advantageously, the second secure execution environment is used to perform comparisons in the clear, which accelerates calculations while preserving the confidentiality of the processed data, as the decrypted data in the second secure execution environment is not accessible by the first execution environment managed by the server.

According to other advantageous aspects of the invention, the method for processing encrypted data comprises one or more of the following features, taken individually or in any technically possible combination.

The calculation of an evaluation vector comprises a calculation of an encrypted difference vector by encrypted subtraction between the encrypted data vector and a vector formed of said decision thresholds.

The calculation of an evaluation vector further comprises a multiplicative masking of the encrypted difference vector by a masking vector.

The multiplicative masking comprises generating the masking vector by pseudo-random drawing of K non-zero values and multiplying said encrypted difference vector and the masking vector to obtain said evaluation vector.

The method comprises the first execution environment, following receipt of at least one encrypted sign vector, combining the masking vector and each component of said encrypted sign vector to obtain an encrypted comparison vector representing the comparison of each component of the encrypted data vector to the corresponding decision threshold.

The determination of the sign of each component of the decrypted evaluation vector by the second secure execution environment further comprises multiplying each sign component by a chosen constant factor, preferably equal to 0.5.

The method further comprises, the first execution environment making an additive adjustment consisting of adding said constant factor to each component of said encrypted sign vector.

The phase of traversing the at least one decision tree is performed by the first execution environment and comprises a calculation of a result vector by level of the decision tree based on said at least one encrypted sign vector.

The method further comprises a calculation of a decision vector based on the result vectors by level.

The calculation of a decision vector comprises an encrypted multiplication of the result vectors by level.

The calculation of a decision vector comprises an encrypted addition of the result vectors by level to obtain an encrypted sum result vector.

The calculation of a decision vector further comprises a bootstrapping step, applied to the encrypted sum result vector, to obtain a decision vector containing a single ‘1’, indicating a terminal result node, and ‘0’ for the other terminal nodes of the decision tree.

The calculation of a decision vector further comprises a step of subtracting a predetermined value, equal to the number of depth levels of the decision tree, from each component of the encrypted sum result vector, and a step of multiplicative masking of the vector resulting from said subtraction step, enabling obtaining a decision vector containing a single ‘0’, indicating a result terminal node, and random values for the other terminal nodes of the decision tree.

The invention also relates to a computer program comprising software instructions that implement a method for processing encrypted data as defined above when executed by a computer.

According to another aspect, the invention relates to a system for processing encrypted data comprising a client and a server providing at least one decision tree, the server being configured to perform an evaluation of a client's encrypted data vector by the at least one decision tree, the client's encrypted data vector being of dimension K, less than or equal to the number of nodes of said at least one decision tree, the evaluation of the encrypted data vector by at least one decision tree, comprising a phase of comparing the components of the encrypted data vector to decision threshold values associated with the nodes of said at least one decision tree, and a phase of traversing the at least one decision tree based on the result of the comparison phase to obtain an encrypted decision result, the system comprising a first execution environment and a second secure execution environment. The system is such that, in the comparison phase:
the first execution environment is configured to implement a homomorphic encryption scheme, a module for calculating an evaluation vector, comprising encrypted components, with each representing a difference between a component of the encrypted data vector and a decision threshold value associated with a corresponding node of said at least one decision tree, and provision of the evaluation vector to said second secure execution environment, executed by said server but controlled by said client, the second secure execution environment being configured to implement:
   a decryption module, by applying a private key of said client, previously recorded in the secure execution environment, of said evaluation vector,
   a module for determining the sign of each component of the decrypted evaluation vector and provision of an encrypted sign vector resulting from said sign determination to said first execution environment.

### BRIEF DESCRIPTION OF THE DRAWINGS

The invention will become clearer upon reading the following description, given solely by way of non-limiting example, and made with reference to the drawings wherein:

FIG. 1 is a system for processing encrypted data comprising a client and a server, the server comprising a computing processor, a first execution environment managed by the server, and a second secure execution environment managed by the client;

FIG. 2 is an example of a binary decision tree;

FIG. 3 represents all the paths of the binary decision tree of FIG. 2;

FIG. 4 is a flowchart of the main steps of a method for processing encrypted data according to a first embodiment;

FIG. 5 is a flowchart of several embodiments of a step of the traversal phase;

FIG. 6 is a flowchart of the main steps of a method for processing encrypted data according to a second embodiment.

### DETAILED DESCRIPTION OF EMBODIMENTS

The invention applies in any application of data evaluation presented in the form of an encrypted data vector by a decision tree provided by a server.

Decision trees are tree-structured algorithms whose parameters are learned by machine learning and used in decision-making. They are used in decision-making for applications of medical data analysis, analysis of industrial equipment operation data in the context of operational diagnostics and predictive maintenance, or detection of security attacks in computer systems, for example.

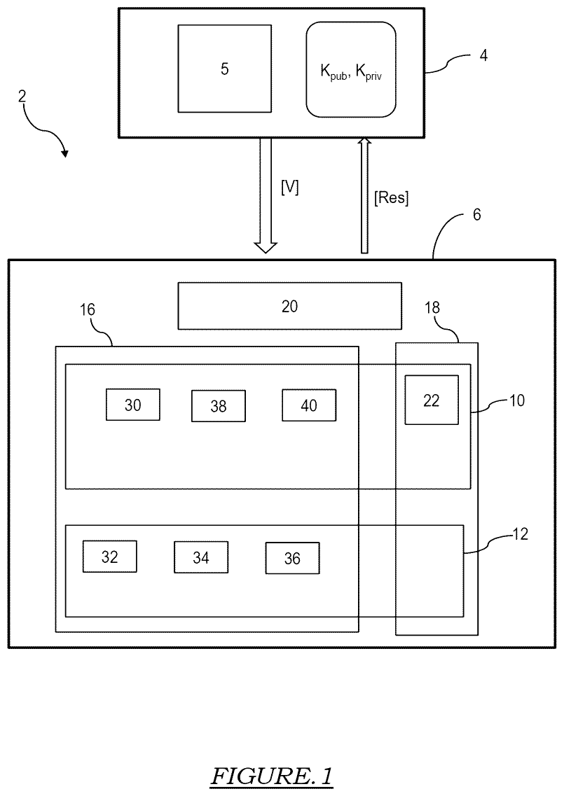

FIG. 1 is a system 2 for processing encrypted data comprising a client system 4 and a server system 6, hereinafter simply referred to as “client 4” and “server 6”.

The system 2 for processing encrypted data is a confidential computing system, wherein encrypted data evaluation calculations are delegated to the server 6 by the client 4.

Each of the systems of the client 4 and the server 6 comprises electronic computing resources.

In embodiments, each of the systems of the client 4 and the server 6 is formed of one or more interconnected programmable electronic devices (or computers).

The client 4 is configured to provide encrypted data according to a homomorphic encryption scheme 5 (or homomorphic cryptosystem), with a public key K_{pub} and a private key Kₚᵣᵢᵥ.

A homomorphic encryption scheme or homomorphic cryptosystem comprises a pair of associated encryption Enc( ) and decryption Deco algorithms, for which the following equality is satisfied for at least one operation in a ring Z:

$$[ MATH 1 ]$$

$$Dec ( Enc ( {m}_{1} ) * Enc ( {m}_{2} ) ) = Des ( Enc ( {m}_{1} ∘ {m}_{2} ) ) = {m}_{1} ∘ {m}_{2}$$

The operations denoted “*” and “o” are operations of the ring Z that may be either identical or distinct.

A cryptosystem is said to be fully homomorphic if the property [MATH 1] is verified for all operations of a ring Z:

Partially homomorphic cryptosystems are also known.

For example, the fully homomorphic cryptosystem TFHE (for “Fully Homomorphic Encryption over the Torus”) is used.

By convention, in the following description, the notation in brackets [X] indicates that the data X is encrypted, and the notation in parentheses (X) indicates that the data X is unencrypted (or in the clear).

Encrypted data is provided in the form of an encrypted data vector [V] of dimension K, K being an integer greater than 1, to the server 6, for evaluation by a binary decision tree or by a random forest comprising a plurality of binary decision trees.

The number K of components of the encrypted data vector to be evaluated is less than or equal to the number of nodes of the binary decision tree.

In the following description, the number K of components of the encrypted data vector to be evaluated is equal to the number of nodes of the binary decision tree.

Decision trees are tree-structured algorithms whose parameters are learned by machine learning in a prior learning phase.

In the description, the case of using a binary decision tree is considered.

The described methods apply to any decision tree, as methods for transforming any tree structure into a binary tree structure such as the “left child right sibling” method are already known.

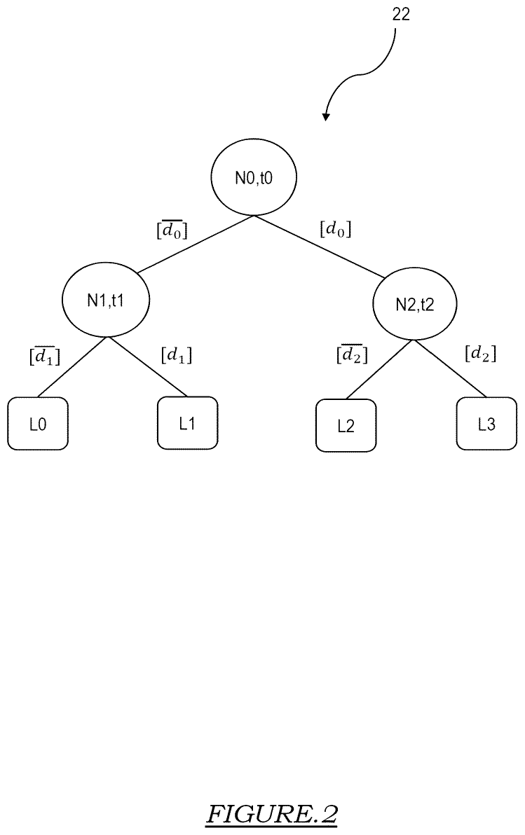

An example of a binary decision tree structure 22 is illustrated in FIG. 2. In the example of FIG. 2, the binary decision tree has D=2 depth levels and comprises K=3 respective nodes {N0, N1, and N2}, each node having an associated decision threshold value {t0, t1, t2}. In a binary tree structure, each node at a given level p has two child nodes at the next level (level p+1). In the simple example illustrated, the node N0 is the root node of the tree, and it has two child nodes, N1 and N2 respectively.

The binary decision tree 22 further comprises M=4 terminal nodes also called “leaves”, noted L0, L1, L2, L3, respectively.

In the example of FIG. 2, each of the nodes N1 and N2 has two respective child nodes, L0 and L1 for node N1 and L2 and L3 for node N2.

Between successive levels, the nodes are linked by branches.

The terminal nodes have no child nodes. The result of the evaluation on a binary decision tree is provided by the terminal nodes.

A traversal of the decision tree for the evaluation of a data vector X=(X₀,X₁,X₂) comprises comparing the respective values of the components Xᵢ to the corresponding decision threshold values tᵢ, with each comparison providing a comparison result [dᵢ] associated with a first branch descending from the node Ni (in the example, the right branch). The complementary result of [dᵢ], noted [d̅ᵢ̅]=1−[dᵢ], is associated with the second branch of the node Ni (in the example, the left branch).

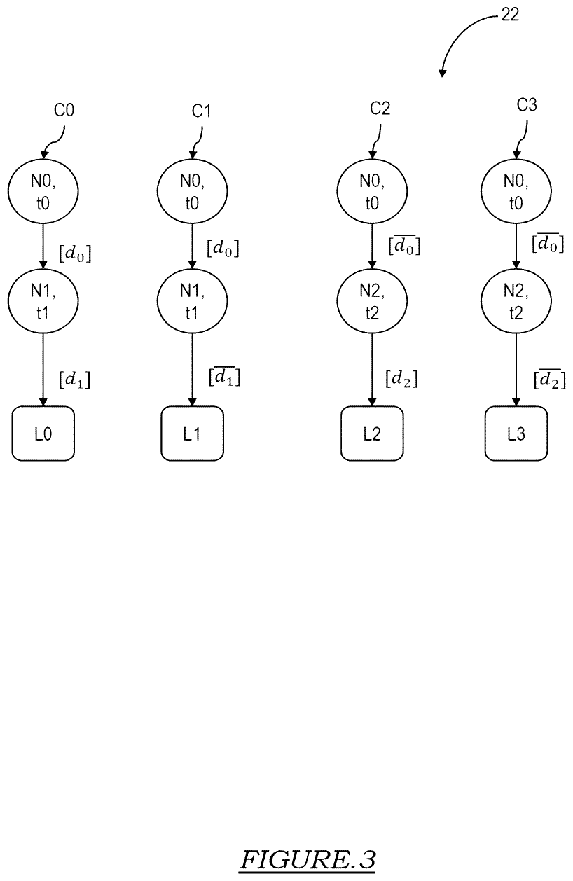

In FIG. 3, the decision tree 22 of FIG. 2 is represented in an unfolded form, wherein all distinct traversal paths of the tree are represented, respectively noted C0, C1, C2, C3, with each path corresponding to a passage from the root node to a terminal node by branches that each have an associated comparison result. A path is characterized by the successive comparison results of the branches forming the path.

An exhaustive traversal of the decision tree comprises evaluating the M possible paths, as represented in FIG. 3.

Of course, the example of FIGS. 2 and 3 is a simplistic example, with binary trees comprising a much larger number of nodes being used in various practical applications.

The client 4 applies a homomorphic encryption scheme to obtain an encrypted data vector [V] that comprises K encrypted components.

Among homomorphic encryption schemes, schemes implementing calculations on a “component-by-component” encryption of the data vector are already known, as well as calculations on a grouped encryption, using the “batching” technique in homomorphic encryption. Homomorphic encryption “batching”, well known to those skilled in the art and described in the article “Fully Homomorphic SIMD Operations” by N. P. Smart and F. Vercauteren, accessible at https://eprint.iacr.org/2011/133.pdf, for example, allows for efficient operations on encrypted vectors instead of performing operations “component by component”.

The methods of the invention described below are applied with any type of homomorphic encryption scheme.

It should be noted that when the calculations are performed “blindly” within the framework of a homomorphic encryption scheme, the evaluation of a decision tree requires the exhaustive calculation of all the paths of the decision tree.

In the case of using component-by-component encryption, the encrypted data vector [V] is written:

$$[ MATH 2 ]$$

$$[ V ] = \{ [ {v}_{0} ] , … , [ {v}_{K - 1} ] \}$$

In the case of grouped encryption with the “batching” technique of all the components of the vector, the encrypted data vector is written:

$$[ MATH 3 ]$$

$$[ V ] = [ {v}_{0} , … , {v}_{K - 1} ]$$

The server 6 comprises a first execution environment 10 and a second secure execution environment 12.

The first execution environment 10 is controlled by the server 6.

The second execution environment 12 is a TEE (for “Trusted Execution Environment”), isolated and secure. This second execution environment is materially executed by the server 6, but it is configured/controlled by the client: it contains secret information of the client 4, which is not accessible by other entities of the server 6, in particular by the first execution environment 10. The hardware and software implementation of a TEE in a computing system is already known.

For example, the second secure execution environment 12 is implemented by secure enclaves, such as Intel® SGX enclaves.

By means of the separation of the two execution environments, different applications can be executed by the second execution environment 12, in an isolated and secure manner in relation to the first execution environment 10, which is the “standard” execution environment implemented by the server.

The use of a second secure execution environment 12 (or TEE 12) ensures the confidentiality of the data processed in the TEE 12, even when the server 6 adopts malicious behavior.

According to distinct embodiments, the first execution environment 10 and the second execution environment 12 are executed either on the same processor or on separate processors.

Thus, the first execution environment and the second execution environment are isolated, materially and/or through separation schemes at the operating system level.

In the embodiment described with reference to FIG. 1, the server 6 comprises a computing unit 16 composed of one or more processors, an electronic memory unit 18, and a communication unit 20, configured to communicate with the client 4.

The first execution environment 10 and the second secure execution environment 12 (or TEE 12) are configured to interact for the implementation of the method for processing encrypted data from the client 4, using the homomorphic cryptography scheme 5.

In order to preserve the confidentiality of the client's data, the first execution environment 10 processes the client's data only in encrypted form and performs “blind” calculations on the encrypted data using the homomorphic cryptography scheme 5.

Advantageously, the second secure execution environment 12, which is controlled by the client, implements the client's private key Kₚᵣᵢᵥ to decrypt the client's encrypted data, allowing for calculations in the clear.

The processing of encrypted data implements an evaluation of one or more decision trees 22, previously trained by machine learning for a specific task. The decision tree(s) 22 are part of the data of the server 6, maintained in the first execution environment 10.

In the following description, the case of evaluation on one decision tree 22 will be described, with it understood that the embodiments described below apply analogously to the evaluation on multiple decision trees.

Preferably, according to embodiments described below, the decision tree(s) 22 are protected so that, when the TEE 12 adopts an “honest but curious” behavior, the TEE 12 cannot obtain information related to the decision trees 22.

The method for processing encrypted data comprises a phase of comparing the components of the encrypted data vector to respective decision thresholds, with each decision threshold being associated with a distinct node of the decision tree. The comparison phase is followed by a phase of traversing the decision tree 22 to provide an evaluation result [Res], with this result being sent to the client in encrypted form, then decrypted by the client.

The first execution environment 10 is configured to implement a module 30 for calculating an evaluation vector comprising encrypted components representing the difference between components of the encrypted data vector and decision threshold values, with each threshold value being associated with a corresponding node.

The first execution environment 10 is configured to provide the evaluation vector to the TEE 12.

The TEE 12 implements a decryption module 32 and a module 34 for determining the sign of each component of the evaluation vector, and a module 36 for providing an encrypted sign vector. The encrypted sign vector is transmitted by the TEE 12 to the first execution environment 10.

The first execution environment 10 implements a module 38 for calculating an encrypted comparison vector and a module 40 for calculating a result of the traversal of the decision tree 22 for the encrypted data vector [V] of the client 4.

In one embodiment, the modules 30, 32, 34, 36, 38, 40 are implemented as software instructions forming a computer program, which implements a method for processing encrypted data as described when executed by a programmable electronic device.

In an unrepresented variant, the modules 30, 32, 34, 36, 38, 40 are each implemented as programmable logic components, such as FPGAs (Field Programmable Gate Arrays), microprocessors, GPGPU components (General-purpose processing on graphics processing), or dedicated integrated circuits, such as ASICs (Application Specific Integrated Circuits).

The computer program comprising software instructions is also capable of being recorded on a non-transitory, computer-readable information recording medium. This computer-readable medium is a medium capable of storing electronic instructions and being coupled to a bus of a computer system, for example. This medium is an optical disk, a magneto-optical disk, a ROM, a RAM, any type of non-volatile memory (e.g., EPROM, EEPROM, FLASH, NVRAM), a magnetic card, or an optical card, for example.

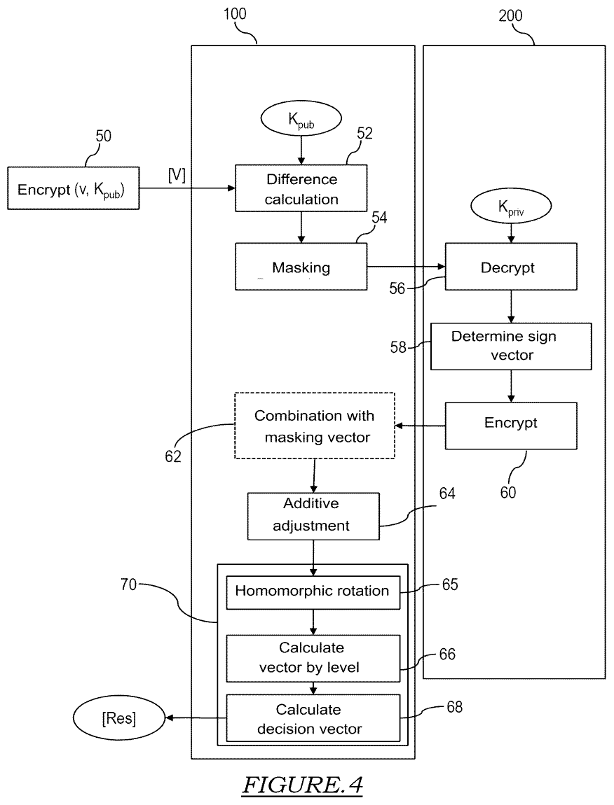

FIG. 4 is a flowchart of the main steps of a method for processing encrypted data according to one embodiment.

The method comprises steps 100, performed by the first execution environment 10 of the server, and steps 200, performed by the second secure execution environment 12 of the server.

The client 4 performs an encryption 50 of data to be processed, using the client's public key K_{pub}, and provides an encrypted data vector [V] to the server 6.

In this first embodiment, the homomorphic encryption scheme used supports grouping or “batching”.

For example, the homomorphic encryption scheme is a BFV (for “Brakerski-Fan-Vercauteren”), BGV (for “Brakerski-Gentry-Vaikuntanathan”), or CKKS (“Cheon-Kim-Kim-Song”) cryptosystem, these various cryptosystem types already being known in the field of homomorphic encryption.

As already explained, all computational operations implemented by the first execution environment 10 of the server 6 are performed on encrypted data, without decryption, using the chosen homomorphic encryption scheme.

The first execution environment 10 receives an encrypted data vector [V], to be evaluated by an evaluation tree 22, and implements a step 52 of calculating an evaluation vector on the binary decision tree.

In one embodiment, the binary decision tree comprises K nodes, with K being the number of components of the encrypted data vector [V].

Each node Ni of the decision tree to be applied has an associated decision threshold value ti. The decision threshold values are the components of a decision threshold vector T: T=(t₀, . . . , t_{K-1})

The decision threshold vector is in the clear, with the decision threshold values being data of the server 6.

During step 52, the first execution environment 10 implements a “encrypted/clear” subtraction, enabling obtaining an encrypted difference vector:

$$[ MATH 4 ]$$

$$[ {V}_{sub} ] = [ {v}_{0} , … , {v}_{K - 1} ] - ( {t}_{0} , … , {t}_{K - 1} ) = [ {v}_{0} - {t}_{0} , … , {v}_{K - 1} - {t}_{K - 1} ]$$

The obtained encrypted difference vector [v_{sub}] is an evaluation vector of the differences, node by node, between the encrypted components of the encrypted data vector and the decision threshold values of the decision tree.

Thus, if the component vₖ has a value greater than or equal to the decision threshold value tₖ, the difference vₖ−tₖ, component of index k of the difference vector, is a positive real number or zero; if the component vₖ has a value strictly less than the decision threshold value tₖ, the difference vₖ−tₖ, component of index k of the difference vector, is a negative real number.

Optionally, the first execution environment 10 implements a step 54 of multiplicative masking of the encrypted difference vector, by multiplying the obtained encrypted difference vector at step 52 by a masking vector. This preserves the confidentiality of the decision threshold values.

Alternatively, in applications where the client and the secure execution environment 12 are considered reliable and honest, the step 54 of multiplicative masking of the encrypted difference vector can be omitted.

During the masking step 54, a masking vector R of dimension K is generated, by pseudo-random drawing, for example. The masking vector, or a vector comprising the signs of the masking vector, is stored in a memory unit accessible by the first execution environment. The masking vector R has non-zero pseudo-random real components rᵢ, with randomly positive or negative signs:

$$R = ( {r}_{0} , … , {r}_{K - 1} ) \qquad [ MATH 5 ]$$

The encrypted difference vector is multiplied, component by component, by the masking vector R, and a masked difference vector is obtained:

$$[ {V}_{s u {b}_{-} m} ] = [ {r}_{0} \times ( {v}_{0} - {t}_{0} ) , … , {r}_{i} \times ( {r}_{i} - {t}_{i} ) , … , {r}_{K - 1} \times ( {v}_{K - 1} - {t}_{K - 1} ) ] \qquad [ MATH 6 ]$$

The masked difference vector obtained at the end of the masking step 54 is an evaluation vector of the differences, comprising components representing the difference between the encrypted components of the encrypted data vector and the decision threshold values.

The evaluation vector obtained at the end of step 54 (or alternatively step 52) is transmitted to the second secure execution environment 12.

The second secure execution environment 12 implements a decryption 56 using the client's private key Kₚᵣᵢᵥ and obtains a clear evaluation vector Vₑ:

$${V}_{e} = ( {V}_{e , 0} , … , {V}_{e , K - 1} ) \qquad [ MATH 7 ]$$

In the case where the masking step 54 has been implemented, the evaluation vector does not allow inferring information related to the decision threshold values of the decision tree.

The second secure execution environment 12 determines 58 the sign of each component of evaluation vector Vₑ in the clear. Advantageously, this determination operation is performed efficiently in the clear, whereas a determination of sign in a homomorphic cryptosystem is complex.

Advantageously, at step 58 of determination of the sign, a sign vector whose each component is multiplied by a chosen constant factor, preferably equal to 0.5, is calculated:

$${V}_{si g n} = ( \frac{1}{2} \times s g n ( {V}_{e , 0} ) , … , \frac{1}{2} \times sgn ( {V}_{e , K - 1} ) ) \qquad [ MATH 8 ]$$

Where sgn(x) is the sign function:

$$\begin{matrix}sgn ( x ) = 1 si x \geq 0 \\ sgn ( x ) = - 1 si x < 0\end{matrix} \qquad [ MATH 9 ]$$

The sign vector v_{sign} obtained as a result of the determination step 58 is then encrypted, according to the homomorphic encryption scheme, with the client's public key K_{pub} at the encryption step 60, and the encrypted sign vector [v_{sign}] is transmitted to the first execution environment 10.

When the masking step 54 has been implemented, the first execution environment 10 implements a step 62 of combining the encrypted sign vector [v_{sign}] received from the second secure execution environment with the masking vector R.

The combination 62 consists of an “encrypted/clear” multiplication of the received encrypted sign vector with the signs of the corresponding component of the masking vector. The respective signs of the masking vector R are known by the first execution environment, so they are used in the clear.

Thus, the random modification of the signs of the components of the difference vector, performed at the masking step 52, is canceled.

At the end of the combination step 62, an encrypted comparison vector is obtained:

$$[ {V}_{c o m p} ] = [ {V}_{s i g n , 0} \times sign ( {r}_{0} ) , … , {V}_{s i g n , K - 1} \times sign ( {r}_{K - 1} ) ] \qquad [ MATH 10 ]$$

In an optional variant, when the masking step 54 has been omitted, the encrypted comparison vector is the received encrypted sign vector.

The first execution environment 10 then implements a step 64 of in the clear/encrypted additive adjustment consisting of adding the constant factor applied at step 58 by the second execution environment.

In the described embodiment, the applied constant factor is equal to 0.5:

$$[ {V}_{comp - final} ] = [ {V}_{s i g n , 0} \times sign ( {r}_{0} ) + \frac{1}{2} , … , {V}_{s i g n , K - 1} \times sign ( {r}_{K - 1} ) + \frac{1}{2} ] \qquad [ MATH 11 ]$$

The additive adjustment operation performed at step 64 enables obtaining an encrypted comparison vector (which is the final result of the comparison phase), whose each component of a given index i represents the result of the comparison of the component of index i of the encrypted data vector [V] to the decision threshold value tᵢ of the node Ni:

$$[ {V}_{comp - final} ] = [ ( {v}_{0} \geq {t}_{0} ? ) , … , ( {v}_{K - 1} \geq {t}_{K - 1} ? ) ] \qquad [ MATH 12 ]$$

The result of the comparison for each component is either an encrypted 0 or an encrypted 1:

$$\begin{matrix}{V}_{comp - final , k} = [ {d}_{k} ] = [ 0 ] si {v}_{k} < {t}_{k} et \\ {V}_{comp - final , k} = [ {d}_{k} ] = [ 1 ] si {v}_{k} \geq {t}_{k}\end{matrix} \qquad [ MATH 13 ]$$

The encrypted comparison vector comprises K components.

Steps 52 to 64 are part of the phase of comparing the components of the encrypted data vector to decision threshold values associated with the nodes of the decision tree.

The method then comprises a phase 70 of traversing the decision tree based on the result of the comparison phase.

Like the comparison phase, the traversal phase 70 is confidential; the steps implemented by the first execution environment 10 are performed on encrypted data using the homomorphic encryption scheme.

In the first embodiment, the calculations are performed with the “batching” technique. The steps of the traversal phase are all implemented by the first execution environment.

The traversal phase 70 comprises a step 65 of implementing homomorphic rotations to obtain shifted vectors from the encrypted comparison vector, with each vector shifted with a circular shift of j positions having K rearranged components: [dⱼ, . . . , d_{K-1}, d₀, . . . , dⱼ₋₁].

The implementation of homomorphic rotations in an FHE cryptosystem is well known to those skilled in the art.

The traversal phase 70 further comprises a step 66 of calculating a result vector by level of the decision tree from the shifted vectors calculated by homomorphic rotation, with each result vector by level having the size M, with M being the number of terminal nodes.

Referring to the example of FIG. 3, a result vector of size M=4 is associated with each level of the decision tree:

$$\begin{matrix}[ {Vr}_{0} ] = [ {d}_{0} , {d}_{0} , \overline{{d}_{0}} , \overline{{d}_{0}} ] is the first - level result vector , \\ [ {Vr}_{1} ] = [ {d}_{1} , \overline{{d}_{1}} , {d}_{2} , \overline{{d}_{2}} ] is the second - level result vector\end{matrix} \qquad [ MATH 14 ]$$

The structure of the result vectors by level can be generalized to any number of levels.

At step 66, the result vectors by level of size M are calculated from the encrypted values of the comparison results at each node, obtained at the previous step 65.

The traversal phase then comprises a step 68 of calculating the decision vector.

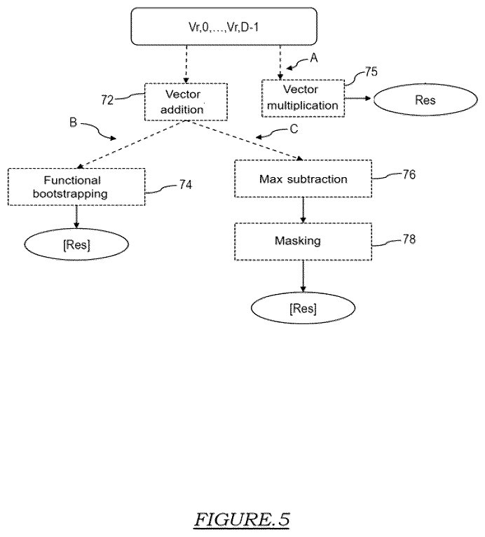

Several embodiments of the decision vector calculation step 68 are described below with reference to FIG. 5. In this figure, the dotted lines indicate alternatives.

In the first embodiment (branch A of FIG. 5), the calculation step 68 is performed by a homomorphic multiplication 75 of the result vectors by level calculated at step 66.

The result sought corresponds to the traversal path in the decision tree wherein all comparisons are positive, or, in other words, the values representing the comparison of the component of the encrypted data vector [V] to the corresponding decision threshold value are all different from [0].

The component-by-component multiplication of the result vectors by level calculated at step 66 enables obtaining a decision vector with only one non-zero component, such a result also being known as “1-hot encoding” in English. The index of the non-zero component enables identifying the corresponding leaf in the decision tree and deducing the result [Res] of the evaluation.

For example, referring to the decision tree represented in FIGS. 2 and 3, if for an encrypted data vector [V]=[V₁,V₂,V₃], the obtained comparison results are: d₀=0, d₁=1, d₂=1, the result vectors by level are, respectively, applying the formulas [MATH 14]:

$$\begin{matrix}[ Vr , 0 ] = [ 0 , 0 , 1 , 1 ] \\ [ Vr , 1 ] = [ 1 , 0 , 1 , 0 ]\end{matrix} \qquad [ MATH 15 ]$$

The multiplication of these vectors gives the following result: [0,0,1,0], which is the decision vector in this embodiment. Only the component of index 2 is equal to 1, with the other components being equal to 0.

The result indicates the path C2 and the terminal node L2.

The encrypted result is transmitted to the client 4, who decrypts it to obtain the decision of the evaluation of the encrypted data vector [V] by the decision tree implemented by the server 6.

In a second embodiment (branch B of FIG. 5) and a third embodiment (branch C of FIG. 5), the decision vector calculation step comprises a homomorphic addition 72 of the result vectors by level.

A sum result vector is obtained:

$$[ V {r}_{s u m} ] = {\sum }_{i = 0}^{D - 1} [ V r , i ] \qquad [ MATH 16 ]$$

When each comparison result comprises the respective value 0 or the value 1, the sum result vector has a component with a maximum value equal to the number D of depth levels.

For example, when the result vectors by level are those of the formula [MATH 15], the obtained sum result vector is:

$$[ {Vr}_{sum} ] = [ 1 , 0 , 2 , 1 ] \qquad [ MATH 17 ]$$

In the second embodiment, the calculation further comprises a step 74 of functional bootstrapping, a technique well known to those skilled in the art in the field of homomorphic encryption, which allows converting encrypted content into encrypted content with a reduced noise level. Step 74 aims to replace the maximum value component of the sum result vector with the value [1], and all other values of the sum result vector components with [0], so as not to reveal additional information about the traversal of the decision tree.

The decision vector is obtained at the end of step 74.

In the third embodiment (branch C of FIG. 5), the homomorphic addition step 72 is followed by a step 76 of subtracting the value D equal to the number of depth levels from each encrypted component of the sum result vector.

For example, when the sum result vector is that of the formula [MATH 17], the calculation performed at the subtraction step 76 is:

$$[ Res ] = [ V {r}_{s u m} ] - ( 2 , 2 , 2 , 2 ) = [ - 1 , - 2 , 0 , - 1 ] \qquad [ MATH 18 ]$$

The vector resulting from step 76 will contain a component equal to [0], indicating the result, with the other components having negative values.

Then, a masking 78 similar to the previously described multiplicative masking by a vector R′ with random values is performed at the masking step 54.

During the masking 78, the vector R′ is generated, with components of non-zero pseudo-random values and randomly positive or negative signs.

In embodiments, the vector R′ is distinct from the masking vector R used for the multiplicative masking at the masking step 54.

The multiplicative masking involves the “encrypted/clear” multiplication of the components of the vector resulting from step 76 [Vres] with the components of the vector R, to form the decision vector in this embodiment. The multiplicative masking retains a component of index k equal to [0], indicating the result index.

The encrypted decision vector [Res], indicating the decision result, is transmitted to the client.

In the above description, the comparison phase of the encrypted data processing method is performed by interaction between the first execution environment and the second execution environment, and the traversal phase of the decision tree is performed by the first execution environment.

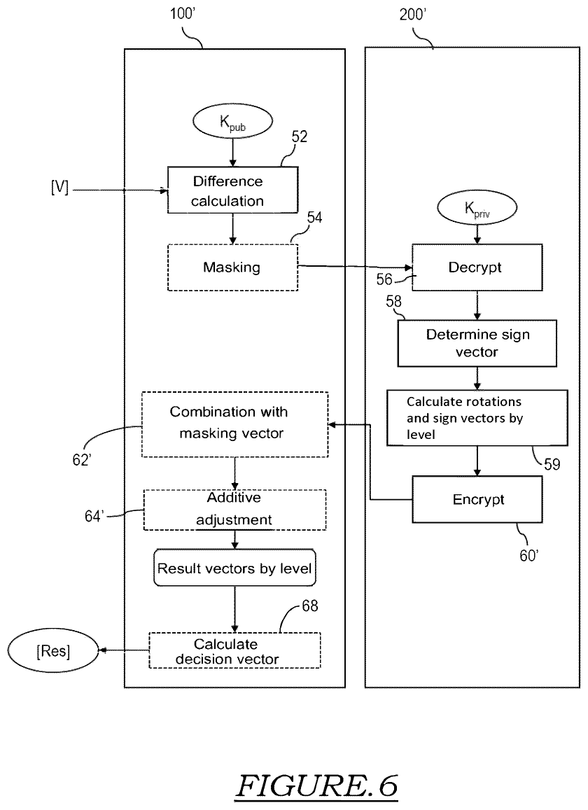

According to a variant described with reference to FIG. 6, the traversal phase of the decision tree is also performed by interaction between the first execution environment and the second execution environment. The steps that are executed in the manner described above, according to all the alternatives, bear the same reference number and are not re-described below.

In the embodiment of FIG. 6, the second secure execution environment further implements a step 59 of calculating rotations, in the clear, of the sign vector V_{sign} explained in [MATH 8], enabling obtaining sign vectors by level.

Indeed, the sign vector comprises K components equal to ½ or −½, respectively, representing the signs of the received evaluation vector components, and more precisely corresponding to the signs of the masked components of the received evaluation vector.

Based on the ranks of the components in the sign vector and the number of levels of the decision tree, the sign vectors by level are calculated.

For example, in the case where D=2, the obtained sign vectors by level are, respectively:

$$\begin{matrix}{V}_{{s}_{-} n i v 0} = ( {V}_{s i g n , 0} , {V}_{s i g n , 0} , 1 - {V}_{s i g n , 0} , 1 - {V}_{s i g n , 0} ) \\ {V}_{{s}_{-} n i v 1} = ( {V}_{s i g n , 1} , 1 - {V}_{s i g n , 1} , {V}_{s i g n , 2} , 1 - {V}_{s i g n , 2} )\end{matrix} \qquad [ MATH 19 ]$$

Each sign vector by level is encrypted at the encryption step 60′ and transmitted in encrypted form to the first execution environment.

The method then comprises a combination 62′ of each received encrypted sign vector by level with the sign of the components of the masking vector R, and a step 64′ of additive adjustment of each sign vector by level after masking.

The combination steps 62′ and additive adjustment 64′ are analogous to the combination steps 62 and additive adjustment 64, but adapted to the sign vectors by level.

At the end of the level adjustment step, the result vectors by level, encrypted, analogous to the result vectors by level obtained at the end of step 66 of the first embodiment, are obtained at the end of step 64′.

The method, in this second embodiment, then comprises the step 68 of calculating a decision vector, performed analogously, according to all its variants, to the first embodiment.

The invention has been described above more specifically for a homomorphic encryption scheme supporting grouped calculations (“batching”).

In a variant, within the reach of those skilled in the art, the methods are described with a homomorphic encryption scheme, wherein calculations are performed component by component. However, the calculations require more computational resources in this variant.

1. A method for processing encrypted data comprising an evaluation of a client's encrypted data vector by at least one decision tree provided by a server, the client's encrypted data vector being of dimension K, less than or equal to the number of nodes of said at least one decision tree, the evaluation of the encrypted data vector by at least one decision tree comprising a phase of comparing the components of the encrypted data vector to decision threshold values associated with the nodes of said at least one decision tree, and a phase of traversing the at least one decision tree based on the result of the comparison phase, to obtain an encrypted decision result, the method being implemented by said server and comprises, in the comparison phase:
by a first execution environment, implementing a homomorphic encryption scheme, a calculation of an evaluation vector, comprising encrypted components, with each representing a difference between a component of the encrypted data vector and a decision threshold value associated with a corresponding node of said at least one decision tree,
provision of the evaluation vector to a second execution environment, which is a secure execution environment, executed by said server but controlled by said client,
by the second secure execution environment:
decryption of said evaluation vector, by applying a private key of said client, previously recorded in the secure execution environment,
determination of the sign of each component of the decrypted evaluation vector and provision of at least one encrypted sign vector resulting from said sign determination to said first execution environment.

2. The method according to claim 1, wherein the calculation of an evaluation vector includes a calculation of an encrypted difference vector by encrypted subtraction between the encrypted data vector and a vector formed of said decision thresholds.

3. The method according to claim 2, wherein the calculation of an evaluation vector further comprises a multiplicative masking of the encrypted difference vector by a masking vector.

4. The method according to claim 3, wherein said multiplicative masking comprises generating the masking vector by pseudo-random drawing of K non-zero values and multiplying said encrypted difference vector and the masking vector, to obtain said evaluation vector.

5. The method according to claim 3, comprising, by the first execution environment following receipt of at least one encrypted sign vector, a combination of the masking vector and each component of said encrypted sign vector, to obtain an encrypted comparison vector representing the comparison of each component of the encrypted data vector to the corresponding decision threshold.

6. The method according to claim 1, wherein the determination of the sign of each component of the decrypted evaluation vector by the second secure execution environment further comprises multiplying each sign component by a chosen constant factor, preferably equal to 0.5.

7. The method according to claim 6 further comprising, by the first execution environment, an additive adjustment consisting of adding said constant factor to each component of said encrypted sign vector.

8. The method according to claim 1, wherein the phase of traversing the at least one decision tree is performed by the first execution environment, and comprises a calculation of a result vector by level of the decision tree based on said at least one encrypted sign vector.

9. The method according to claim 8, further comprising a calculation of a decision vector based on the result vectors by level.

10. The method according to claim 9, wherein the calculation of a decision vector comprises an encrypted multiplication of the result vectors by level.

11. The method according to claim 9, wherein the calculation of a decision vector comprises an encrypted addition of the result vectors by level, to obtain an encrypted sum result vector.

12. The method according to claim 11, wherein the calculation of a decision vector further comprises a bootstrapping step applied to the encrypted sum result vector, to obtain a decision vector containing a single ‘1’, indicating a terminal result node, and ‘0’ for the other terminal nodes of the decision tree.

13. The method according to claim 11, wherein the calculation of a decision vector further comprises a step of subtracting a predetermined value, equal to the number of depth levels of the decision tree, from each component of the encrypted sum result vector, and a step of multiplicative masking of the vector resulting from said subtraction step, enabling obtaining a decision vector containing a single ‘0’ indicating a terminal result node and random values for the other terminal nodes of the decision tree.

14. A computer program comprising software instructions that implement a method for processing encrypted data according to claim 1, when executed by a programmable electronic device.

15. A system for processing encrypted data, comprising a client and a server providing at least one decision tree, the server being configured to perform an evaluation of a client's encrypted data vector by the at least one decision tree, the client's encrypted data vector being of dimension K, less than or equal to the number of nodes of said at least one decision tree,
the evaluation of the encrypted data vector by at least one decision tree comprising a phase of comparing the components of the encrypted data vector to decision threshold values associated with the nodes of said at least one decision tree, and a phase of traversing the at least one decision tree based on the result of the comparison phase, to obtain an encrypted decision result, with the system comprising a first execution environment and a second secure execution environment,
wherein, in the comparison phase:
the first execution environment is configured to implement a homomorphic encryption scheme, a module for calculating an evaluation vector, comprising encrypted components with each representing a difference between a component of the encrypted data vector and a decision threshold value associated with a corresponding node of said at least one decision tree, and provision of the evaluation vector to said second secure execution environment, executed by said server but controlled by said client,
the second secure execution environment being configured to implement:
a decryption module, by applying a private key of said client, previously recorded in the secure execution environment, of said evaluation vector,
a module for determining the sign of each component of the decrypted evaluation vector and provision of an encrypted sign vector resulting from said sign determination to said first execution environment.
